(19) United States
(12) Patent Application Publication
(10) Pub. No.: US 2017/0015411 A1
(43) Pub. Date: Jan. 19, 2017

(54) DRIVE CHAIN FOR A HELICOPTER INCORPORATING A PYROTECHNIC ASSISTANCE DRIVE MODULE AND HELICOPTER COMPRISING THE SAME

(71) Applicant: SAFRAN HELICOPTER ENGINES, Bordes (FR)

(72) Inventor: Jean-Louis Robert Guy BESSE, Nay (FR)

(21) Appl. No.: 15/300,739

(22) PCT Filed: Mar. 30, 2015
(86) PCT No.: PCT/FR2015/050817

§ 371 Date: Sep. 29, 2016

(30) Foreign Application Priority Data
Apr. 3, 2014 (FR) 1452989

(51) Int. Cl. B64C 27/14; F01D 13/00; F02C 7/272; B64C 27/00

(52) U.S. Cl. CPC B64C 27/14; B64C 27/006; F01D 13/003; F02C 7/272; F05D 2220/329

(57) ABSTRACT

The invention relates to a drive chain for driving the rotor(s) (21, 22) of a helicopter, comprising a main transmission gearbox (24) capable of driving the rotor(s) (21, 22) when said gearbox is moving, a main engine (23) for providing the power for the flight, and at least one assistance drive module (31), the main engine (23) and the assistance drive module (31) being mechanically connected to said main transmission gearbox (24) so as to induce the movement of said gearbox. The drive chain is characterised in that the assistance drive module comprises a pyrotechnic device for generating a torque on a power transmission shaft that is mechanically connected to the main transmission gearbox (24). The invention also relates to a helicopter comprising said drive chain.

### FIELD OF THE INVENTION

The present invention relates to the field of helicopter propulsion. Specifically, the invention relates to the use of rotary pyrotechnic actuators for supplying additional power during difficult flight phases such as autorotation.

### PRIOR ART

A helicopter is conventionally provided with a main rotor, which forms a rotary wing to lift and propel said helicopter. The helicopter also comprises an anti-torque means that is often formed by a second, rear rotor.

Single-engine helicopters have great advantages compared with multi-engine helicopters, in particular in terms of production and maintenance costs.

However, if the engine of a single-engine helicopter breaks down or malfunctions, the pilot has to perform the difficult autorotation manoeuvre for an emergency landing. Statistics show that in some conditions this manoeuvre can cause significant damage to the airframe.

There is therefore a need to install a means capable of providing potential supplementary power very quickly in order to increase the safety of the autorotation manoeuvre in a single-engine helicopter, while preventing the rotor revolution from dropping during any phase of this manoeuvre.

EP2327625 already proposed installing such a system for providing emergency power at the input of the main transmission gearbox that drives the rotary wing of a helicopter. This system uses an electric motor, which has the advantage of being able to quickly start rotating and of having power that can be controlled depending on the driving problem to be fixed.

However, this kind of electromechanical solution requires batteries, control electronics and an electric motor onboard. All this equipment, especially the batteries, affects the weight estimation for the airframe, despite being used very occasionally.

The aim of the invention is to provide a simple alternative to avoid affecting the weight estimation of the helicopter.

### DISCLOSURE OF THE INVENTION

In this respect, the invention relates to a drive chain for driving the rotor(s) of a helicopter, comprising a main transmission gearbox capable of driving the rotor(s) when said gearbox is moving, a main engine for providing the power for the flight, and at least one assistance drive module. The engine and the assistance drive module are mechanically connected to said main transmission gearbox so as to induce the movement of said gearbox. The drive chain is characterised in that said assistance drive module comprises a pyrotechnic gas generation device for generating a torque on a power transmission shaft mechanically connected to the main transmission gearbox.

A first advantage of a pyrotechnic device is its energy density. The assistance drive that uses said device can thus be designed to have a lesser effect on the weight estimation of the airframe while still providing sufficient power for an emergency manoeuvre by supplying a torque for maintaining the movement of the rotors.

Another advantage of the pyrotechnic device is that of being able to simplify the onboard electronics for controlling said device. The power curve provided over time depends on the design of the device. When it is produced, the assistance drive module having the pyrotechnic device is thus calibrated such as to provide a suitable power curve for the helicopter without complementary control means.

Advantageously, said assistance drive module comprises at least one flyer that can rotate about an axis of symmetry, said flyer comprising a drum rigidly connected to a power transmission shaft, at least one gas ejection nozzle positioned on the periphery of the drum and oriented substantially tangentially to the rotation about said axis, said pyrotechnic gas generation device being installed in the flyer and feeding said at least one exhaust nozzle.

In other words, the exhaust nozzles produce tangential gas ejection jets for generating a torque on the flyer shaft. The device can thus be used to both provide a torque at the input of the main transmission gearbox if the main engine fails, and maintain the movement of the rotors. With regard to a single usage, the pyrotechnic device allows gases to be generated in a chamber upstream of the exhaust nozzles at a high pressure and temperature, thus creating thrust and therefore the torques required for driving the rotary wing during the manoeuvre being made. In this case, the main engine is not necessarily restarted, but rather the necessary power is provided to the helicopter in order to complete a manoeuvre or to perform an emergency manoeuvre to allow the helicopter to get to safety.

The fact that the pyrotechnic gas generation device is installed in the flyer reduces the transfer problems and the losses during the operation thereof. Moreover, the principle of the flyer means that it can be positioned on the rotary machine and said rotary machine can rotate the flyer during normal operation, i.e. when the assistance drive module is not operating. Indeed, the flyer creates few friction losses and is not at risk of being used prematurely.

Preferably, the pyrotechnic gas generation device comprises a block of solid propellant in which there is formed a combustion chamber that feeds said at least one exhaust nozzle. This makes it simpler to maintain the device. It is thus conceivable to replace the pyrotechnic device of the assistance drive module in a simple manner after use.

Advantageously, the assistance drive module further comprises a mounting in which the shaft of the flyer rotates, and a volute for recovering the gases, which radially surrounds the flyer and is rigidly connected to said mounting.

The volute helps to expand the gases exiting the exhaust nozzles, and thus, by means of the thrust from said nozzles, contributes to the torque provided by the flyer. It is therefore possible to improve the performance of the flyer by optimising the shape of this volute. Another advantage of this volute is that of the hot gases exiting the exhaust nozzles being discharged radially with respect to the axis of the flyer, thus limiting the extent to which the equipment surrounding the flyer heats up. These gases can then be directed to the outlet of the volute towards a suitable discharge region.

If necessary, said assistance drive module can comprise at least two flyers arranged in a line for driving the same power transmission shaft. A first advantage of this arrangement is the ability to provide a particular power by combining a plurality of standard flyers. Another advantage is that of being able to adjust over time the power provided by the assistance drive module by controlling the successive start-up of the flyers such that it is adapted to the requirements of a manoeuvre.

Said assistance drive module can comprise a mechanical output arranged to directly drive a mechanical input of the main transmission gearbox or to drive the same power transmission shaft connected to the main transmission gearbox as the main engine.

When the main engine is a turbine engine, said assistance drive module can comprise a mechanical output coupled to the spindle of a turbine of the turbine engine. Advantageously, said turbine is the power turbine of the turbine engine. Depending on the installation selected, this option can make it possible to integrate the assistance drive module in the turbine and to further improve the weight estimation.

Advantageously, the assistance drive module further comprises a system for igniting the or said pyrotechnic gas generation device(s), said ignition system comprising a control system that can be placed in an armed mode or a deactivated mode. In particular, this prevents the system from being ignited at the incorrect time.

The invention also relates to a helicopter comprising a drive chain as described above.

The invention also relates to a method for driving the rotary wing of such a helicopter, in which the assistance drive module ignition system can be placed in an armed, deactivated or triggered mode, said method comprising a step of arming said ignition system when a helicopter pilot orders a predetermined manoeuvre, for example autorotation. This step corresponds in particular to the case in which the safety conditions for triggering are satisfied. This enables the system to react quickly when necessary, and to avoid the risk of the system being triggered during normal flight conditions.

### BRIEF DESCRIPTION OF THE DRAWINGS

The present invention will be better understood, and other details, features and advantages of the present invention will become clearer upon reading the following description, given with reference to the accompanying drawings, in which:

FIG. 1 is a perspective view of a flyer for an assistance module according to the invention.

FIG. 2 is a section through half a flyer according to the invention, in a plane that is perpendicular to the axis of rotation and passes through the exhaust nozzles.

FIG. 3 is a longitudinal section through an assistance drive module according to the invention prior to use.

FIG. 4 is a schematic perspective view of one arrangement of the means for discharging the gases on an assistance drive module according to the invention.

FIG. 5 is a schematic section, in a plane perpendicular to the axis of rotation, through the volute for discharging the gases and through the flyer of an assistance drive module according to the invention.

FIG. 6 is a longitudinal section through an assistance drive module according to the invention towards the end of its ignition.

FIG. 7 is a schematic view of a first embodiment of a drive chain according to the invention for a helicopter.

FIG. 8 is a schematic view of a second embodiment of a drive chain according to the invention for a helicopter.

FIG. 9 is a schematic view of a third embodiment of a drive chain according to the invention for a helicopter.

FIGS. 10 to 12 show alternative embodiments of an assistance drive module according to the invention, which can be used in the various embodiments of the drive chain.

### DETAILED DESCRIPTION OF THE INVENTION

The invention relates to the use of a pyrotechnic drive module such as an assistance drive module in a drive chain of a helicopter.

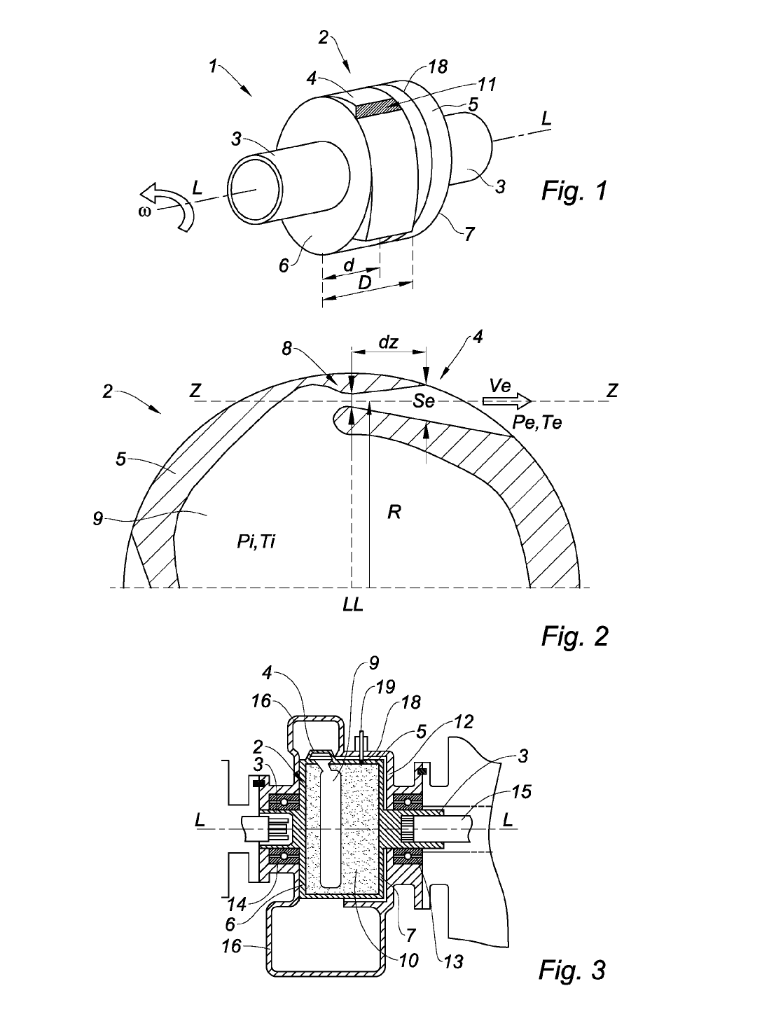

In the example described, as shown by FIGS. 1 to 3, this drive module comprises a flyer 1 consisting of a cylindrical drum 2 and a power transmission shaft 3, which are rigidly interconnected and have the same axis LL about which the assembly is intended to rotate.

With the drum 2 having a given width D along the axis of rotation LL, a plurality of exhaust nozzles 4 are arranged on a narrower strip, of width d, of the peripheral cylindrical wall 5 of said drum. This strip is located at one side of the cylindrical wall 5 of the drum 2. With reference to FIGS. 1 and 2, if, for example, the left transverse surface is denoted the upper surface 6 of the drum 2 and the right transverse surface is denoted the lower surface 7 of the drum, the strip in which the exhaust nozzles 4 are located can, for example, be off-centre as shown, and close to the upper surface 6. The exhaust nozzles 4 are oriented tangentially to the cylindrical wall 5, all facing the same direction. This direction is the same as that of the gas jet that should exit said nozzles, and therefore, in response, it causes the flyer 1 to rotate during operation in the opposite direction to that of the gas jet. In the example, the exhaust nozzles 4 are distributed evenly in azimuth, and there are three of them, with two being visible in FIG. 1.

Still referring to the example, the exhaust nozzles 4 are two-dimensional. This means that they are defined by their shape in a sectional plane transverse to the axis of rotation LL. With reference to FIG. 2, the exhaust nozzle 4 forms a duct of length dz that diverges starting from a neck 8. This neck 8 is located on a radius R of the axis LL of the flyer 1, and the exhaust nozzle 4 is oriented along an axis ZZ that is substantially perpendicular to the radius passing through the neck 8.

Alternatively, it is possible, for example, to design the exhaust nozzles 4 to have an asymmetric shape, depending on the required ease of design and production. In this case, said exhaust nozzles are still defined as a diverging duct oriented along an axis ZZ.

Via the neck 8, the exhaust nozzle 4 is in communication with a combustion chamber 9, which should generate pressurised gas when the flyer 1 is in operation. In the example shown, this combustion chamber 9 is shared by the three exhaust nozzles 4 positioned on the cylindrical wall 5 of the drum 2.

Therefore, the combustion chamber 9 has to be supplied with pressurised gas. With reference to FIG. 3, which shows the flyer 1 prior to use, it can be seen that the drum 2 forms a cavity between its cylindrical wall 5 and its upper surface 6 and lower surface 7. The internal cavity in the drum 2 is filled by a solid block 10 of a material designed to produce high-energy gases when set alight by an ignition device, which is positioned in the region of the combustion chamber 9 but not shown in the drawings. This material is generally made of solid propellant. The space left free in the drum 2 between the strip occupied by the exhaust nozzles 4 and the lower surface 7 is of such a size as to form a sufficient store of propellant, the combustion of which will generate gases for the necessary period of time for the emergency manoeuvre.

In the flyer 1, before use, the combustion chamber 9 which feeds the exhaust nozzles 4 and is intended for receiving the gases produced by the combustion of the propellant is dug out of the propellant block 10 and occupies less space in the region of the exhaust nozzles. Preferably, the exhaust nozzles 4 are sealed by a membrane 11, which is ejected by the pressure of the combustion gases during ignition, thus preventing dust and moisture from entering the combustion chamber 9 when not in the triggered state.

To form a drive module, the flyer 1 is incorporated on a mounting 12 comprising bearings 13, 14, in which the shaft 3 rotates. As shown, the shaft 3 is intended to be coupled to a shaft 15 that drives another mechanical system. The shaft 15 can be an intermediate shaft, referred to as a “shear shaft”, that is designed to break if the transmitted torque accidentally exceeds a maximum permissible value. Furthermore, said shaft is coupled, for example by means of splines, on the shaft 3 of the flyer 1.

As shown in FIGS. 3 to 5, the mounting 12 preferably includes a volute 16. This volute 16 radially surrounds the flyer 1. The volute is designed to allow the gases exiting the exhaust nozzles 4 to expand before discharging them. Together with the portion of the mounting 12 that surrounds the drum 2, the volute forms a duct 16 which winds around the flyer 1. The internal wall of this duct 16 is open opposite the passage for the exhaust nozzles 4 in order to collect the gases exiting said nozzles. In the example shown, the radial cross section of the duct formed by the volute 16 is substantially rectangular.

With reference to FIG. 5, the cross section of the external wall of the volute 16 has a spiral shape around the axis LL of the flyer 1. If φ denotes the azimuth around the axis LL, the distance from the external wall of the volute 16 to the axis follows a law S(φ), which increases steadily in this example, as a function of φ between a point A and a point B in the direction of rotation corresponding to that of the flyer 1 during operation. In FIG. 5, the direction of rotation is anticlockwise and corresponds to exhaust nozzles 4 oriented as in FIG. 2.

In addition, the width of the volute 16 along the axis LL increases in this example from A to B. This is shown by the sections shown in FIGS. 3 and 6, which show the cross section of the volute 16 in the longitudinal sectional half-planes passing through point A (at the top) and point C (at the bottom), which is an intermediate point between A and B and shown in FIG. 5. The cross section of the duct formed by the volute 16 thus steadily changes (increases in the example given here), according to a law S(φ), between the points A and B in azimuth φ to guide the expansion of the gases.

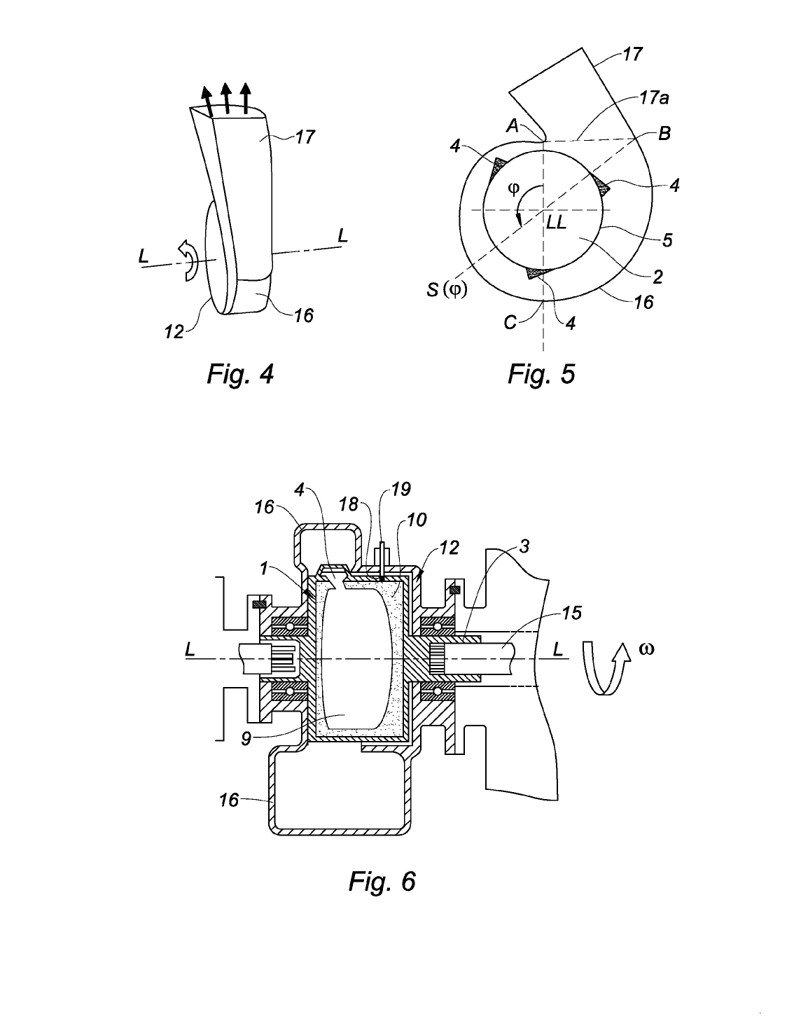

By means of the opening 17a defined in azimuth between the points B and A, the volute 16 leads into an exhaust conduit 17 for discharging the gases, as shown in FIGS. 4 and 5.

When the propellant block 10 is ignited, the combustion starts in the combustion chamber 9, which is in its initial shape as shown in FIG. 3. The combustion chamber 9 fills with pressurised gas and is used as a chamber for supplying the exhaust nozzles 4 with high-energy gas at specified temperature conditions Ti and pressure conditions Pi. This gas exits through the exhaust nozzles 4, thus generating thrust and producing a torque on the shaft 3 of the flyer 1. This shaft 3 rotating at a speed ω is mechanically connected to the rotor of the helicopter. With reference to FIG. 6, as the combustion progresses, the propellant is used up and the volume of the combustion chamber 9 of the exhaust nozzles 4 changes in the block 10 until all the propellant has been used. It is routine practice for a person skilled in the art to determine the initial shape of the combustion chamber 9 and the initial weight of the propellant block 10 so that the pressure conditions Pi and temperature conditions Ti of the gases in the combustion chamber 9 change during this process to provide the torque according to a desired variation over the required time.

During the propellant combustion phase, the pressure Pi is sufficiently high for each of the exhaust nozzles 4 to be primed by a sonic flow to the neck 8. At its outlet cross section, each exhaust nozzle 4 thus creates a gas jet in the direction ZZ tangential to the neck 8. At the outlet cross section Se of the exhaust nozzle 4, this jet reaches a high, supersonic speed Ve, whereas the pressure Pe and the temperature Te of the gases have reduced compared with those of the gases in the combustion chamber 9. This produces a tangential force F, also referred to as thrust, in the opposite direction to the speed Ve, which is dependent on the mass flow rate, on the speed of the jet passing therethrough and on the difference between this outlet pressure Pe of the jet and a static pressure around the flyer 1 in the volute 16. The torque provided by the flyer 1 on the power transmission shaft 3 is the sum of the torques, which, for each exhaust nozzle 4, is this force F multiplied by the radius R of the neck 8.

In a suitable embodiment, the neck 8 is made in and formed, for example, of an abradable, woven and stamped material, such as carbon/ceramics or any other device, so as to reduce as much as possible the transfer of heat by conduction and radiation from the hot gases to the drum 2 when the propellant is combusted. It goes without saying that the configuration shown in the drawings is just one example. A person skilled in the art will adapt the number of exhaust nozzles 4, the size thereof and the distribution thereof in azimuth depending on the torque to be provided and the gas pressure available in the combustion chamber 9. In addition, although the two-dimensional shape of the exhaust nozzles 4 is advantageous in terms of overall size for the device, it is conceivable to use other shapes, in particular an axisym metric shape.

Moreover, the shape of the volute 16 contributes to the output of the exhaust nozzles 4 and thus to the performance of the flyer 1 when ignited. The combustion gases ejected at the speed Ve, pressure Pe and temperature Te from each of the exhaust nozzles 4 continue to expand in the volute 16, while the exhaust nozzle 4 rotates inside the volute 16, and are then discharged to the outside via the exhaust conduit 17.

With reference to FIG. 5, the distribution of the cross section of the volute 16 according to the azimuth φ between points A and B is optimised to achieve a good balance between the level of expansion, which determines the torque provided by the flyer 1, and a gas ejection temperature Te that is compatible with the area surrounding the system. In particular, this balance takes account of the forced-convection phenomena in the volute 16, the conduction by the device fastening means, and the thermal radiation from the assembly.

In addition, the volute 16 contributes to protecting the equipment surrounding the flyer 1 by guiding the gases ejected through the exhaust nozzles 4 towards the conduit 17.

Moreover, the protective membrane 11 that seals each exhaust nozzle 4 while the flyer 1 is not in use is designed to be disintegrated upon ignition under the combined effect of the pressure and the temperature of the gases resulting from the combustion of the propellant. The remains of said membrane are thus discharged naturally with the gases when the flyer 1 starts up.

With reference to FIGS. 1 and 3, to trigger the combustion of the propellant block 10, the pyrotechnic drive module uses an electrical control in the example shown. In the flyer 1, the aforementioned device (not shown in the drawings) for igniting the propellant block 10 is connected to a circular contact track 18 flush with the surface of the cylindrical wall 5 of the drum 2. An electric sliding contact breaker 19 is positioned in contact with the contact track 18 on the mount 12 to send an electric current to the ignition device. The contact breaker 19 is in turn connected to a control system (not shown) that sends the current, via said ignition device, to set the propellant alight in the event of the pyrotechnic drive module having to start up.

The assembly consisting of the ignition device, the contact breaker 19, the control system and the means for connecting these various elements forms a system for igniting the pyrotechnic device.

The invention also covers the possibility of using other means of igniting the propellant block 10 and/or transmitting the ignition order, for example a wireless connection and/or optical or laser means.

Preferably, the ignition system is designed to be armed, i.e. ready to transmit a sufficient current to trigger the combustion, or disarmed, i.e. prevented from doing so. The disarmed position is advantageous in that it prevents accidental ignitions.

A second aspect of the invention relates to installing the pyrotechnic drive module in the drive chain of the helicopter.

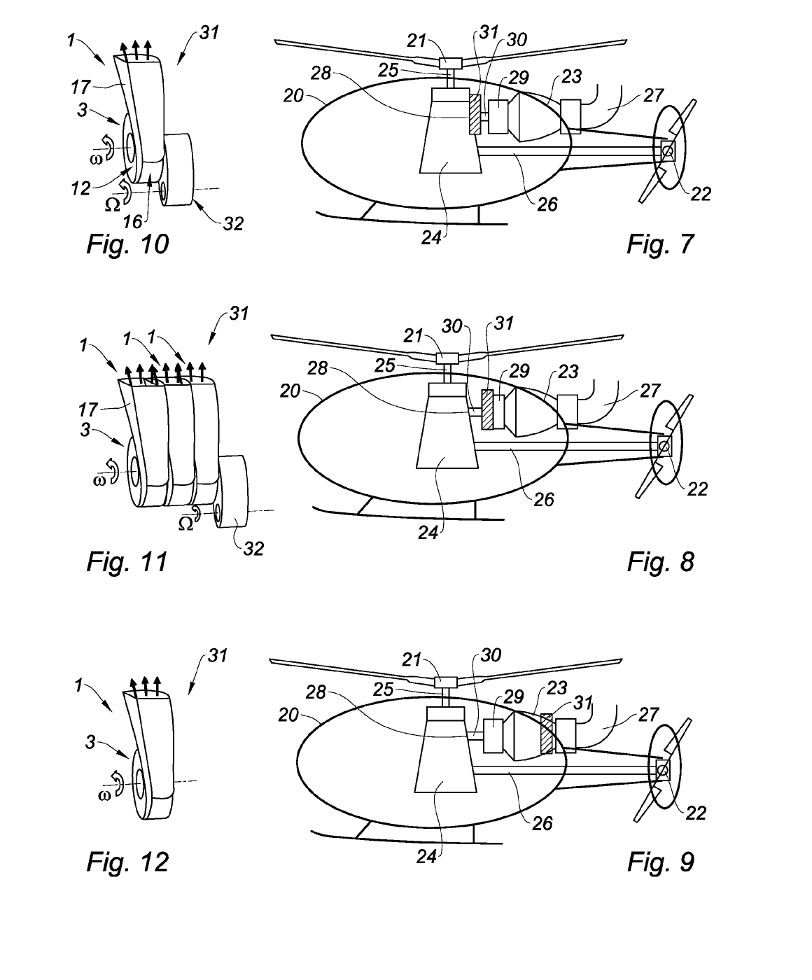

Using the example of a single-engine helicopter, a first embodiment of this installation is shown in FIG. 7.

In this example, the helicopter, the airframe 20 of which is shown schematically, in the typical form in this case, is equipped with a main rotor 21 for lift and propulsion, and an anti-torque tail rotor 22. The drive chain of the helicopter comprises in particular a main engine 23 for providing the necessary power for flying the helicopter, and a main transmission gearbox 24, the function of which is to transmit the power from the main engine to the rotors 21, 22 in order to move said rotors by means of mechanisms, which are shown schematically in the figure by means of a shaft 25 extending towards the main rotor 21 and a shaft 26 extending towards the tail rotor 22. It should be noted that the assistance drive module on which this patent is based can also be integrated in a drive chain for other helicopter architectures, for example a helicopter that has coaxial main rotors or is provided with other anti-torque devices.

The main engine 23 can be a turbine engine (shown here together with its exhaust 27), but can also be an internal combustion engine or an electric engine.

Generally, the main transmission gearbox 24 comprises a mechanical input 28, the internal gears that actuate the shafts 25, 26 extending towards the rotors 21, 22 in this case being driven from this mechanical input. Also, generally the main engine comprises a mechanical output 29, which can be a first set of gears that reduces the number of revolutions and is coupled to the mechanical input 28 of the main transmission gearbox 24 by means of a shaft 30.

In the first embodiment of the installation, shown in FIG. 7, a pyrotechnic drive module 31 is installed at the mechanical input 28 of the main transmission gearbox 24. It can also be coupled directly to said mechanical input 28 or installed on the shaft 30 of the main transmission gearbox 23.

Generally, with reference to FIG. 10, the pyrotechnic drive module 31 includes a reduction gear assembly 32, which thus forms its mechanical output. Indeed, the design of the pyrotechnic drive module generally does not allow the rotational speed ω of the shaft 3 of the flyer to match the nominal rotational speed Ω at which the shaft 30 should be at the mechanical input 28 of the main transmission gearbox 24.

In an alternative embodiment, shown in FIG. 11, a plurality of flyers 1 are installed in a line on the same shaft 3. In this case, just one reduction gear assembly 32 coupled to the shaft 3 can be used to provide the desired rotational speed ω at the output of the pyrotechnic drive module 30.

Each flyer 1 has its own ignition device and contact breakers 19, but the system for igniting the drive module 31 preferably comprises a central control system that is arranged so that the system for igniting the assistance drive module 31 is armed or disarmed as a whole.

The system for igniting the assistance drive 31 can be designed so that the flyers 1 are ignited at the same time. This makes it possible to adapt the power of the pyrotechnic drive 31 to various types of helicopters during the design phase by not using just one type of flyer 1. It is also possible to design the system for igniting the drive module 31 such that the flyers 1 are ignited in sequence, thus allowing the power to be adjusted according to the autorotation flight conditions encountered.

In a second possible embodiment, shown in FIG. 8, the pyrotechnic drive module 31 is installed at the mechanical output 29 of the main engine 23.

Generally, as with the preceding embodiment, this embodiment requires the use of a reduction gear assembly 32 at the output of the pyrotechnic drive module 31 in order to adjust the rotational speed ω of the shaft 3 of the flyers to the rotational speed Ω of the shaft 30 which transmits the power of the main engine 23 to the mechanical input 28 of the main transmission gearbox 24. The two alternative embodiments of the pyrotechnic drive module shown in FIGS. 10 and 11 are equally possible.

A priori, the choice between these two first embodiments will depend on the available space in the helicopter airframe 20 around the drive chain around the appropriate points.

In the two embodiments, the exhaust duct(s) 17 of the flyer(s) 1 can lead into the atmosphere, at the top of the airframe 20. If the main engine 23 is a turbine engine, these exhaust ducts 17 can open into the exhaust 23 of the turbine engine.

With reference to FIG. 9, a third embodiment is conceivable for installing the pyrotechnic drive module 31. Mainly if the main engine 23 is a turbine engine, the drive module can be coupled to the shaft of a power turbine of the turbine engine.

This embodiment can have several advantages. Firstly, the rotational speed of a pyrotechnic flyer 1 can be compatible with that of the shaft of the turbine. In this case, with reference to FIG. 12, the drive module may not include a reduction gear assembly. The mechanical output of the drive module 31 is thus formed by the shaft of the turbine meshing, for example by means of splines, on the shaft 3 of the flyer 1 that couples the “shear” shaft 15 shown in FIG. 3.

Secondly, the exhaust duct 17 of the flyer can be designed such that the gases exiting the flyer are discharged into the gas exhaust circuit of the turbine engine.

By means of these devices, therefore, a more compact and lighter device can be designed. Lastly, as with the other embodiments, a plurality of flyers 1 can be coupled in a line on the shaft 3.

According to an additional aspect of the invention, a helicopter equipped with a drive chain of this type can be operated in stages corresponding to different states of the pyrotechnic assistance drive module 31.

In a first nominal operation stage, for example in the non-dangerous flight phases, the system for controlling the device for igniting the propellant block 10 is disarmed. Optionally, the control system either continuously sends or intermittently sends, upon request, a weak electrical signal to the device for igniting the propellant block 10 in order to detect possible interruptions in the control chain. If a fault is confirmed by the logic of this system, the fault is processed accordingly and a suitable signal is generated. Moreover, the flyer(s) of the assistance drive module is/are stopped if a free wheel coupling has been generated. Otherwise they are driven by the shaft of the drive chain coupled to their mechanical output.

A critical operation stage can be defined for dangerous flight conditions or in the likelihood of an incident occurring. For example, a dangerous flight condition can be when the pilot orders an autorotation phase for landing. In turn, an incident situation can be declared when the kinematics of the mechanical input 28 of the main transmission gearbox 24 are operating at a speed below a first, alarm threshold, outside of the acceleration phase of the rotor kinematics once the main engine 23 has been started up.

In this case, the system for controlling the device for igniting the propellant block 10 is armed. The electrical connection between the contact breaker 19 and the contact track 18 still allows potential anomalies to be detected on the pyrotechnic drive module, and for the fault to be processed accordingly and suitable signals generated.

Finally, an operation stage of the pyrotechnic assistance drive can be triggered, either by an order from the pilot, for example a request for autorotation assistance, or automatically in the event of an incident, for example when the input speed of the main transmission gearbox 24 falls below a second threshold during flight.

In this case, for example, an electrical signal is sent by the control chain to the sliding contact breaker 19 on the track 18 of the flyer 1. This electrical signal thus controls the ignition of the system for igniting the propellant 10 consumed in the combustion chamber 9.

This is when the pyrotechnic drive module 31 generates a torque and drives the main transmission gearbox 24 to actuate the rotors 21, 22. The entire system is designed to allow the torque of the flyer(s) 1 to quickly reach the necessary value for providing the expected power within the required time.

1. A drive chain for driving the rotor(s) of a helicopter, comprising a main transmission gearbox capable of driving the rotor(s) when said gearbox is moving, a main engine for providing the power for the flight, and at least one assistance drive module, the main engine and the assistance drive module being mechanically connected to said main transmission gearbox so as to induce the movement of said gearbox, wherein said assistance drive module comprises:
at least one flyer that can rotate about an axis of symmetry, said flyer comprising a drum that is rigidly connected to a power transmission shaft mechanically connected to the power transmission gearbox, at least one gas ejection nozzle located on the periphery of the drum and oriented substantially tangentially to the rotation about said axis of symmetry,
a pyrotechnic gas generation device which is installed in the flyer and feeds said at least one exhaust nozzle.

2. The drive chain according to claim 1, wherein said assistance drive module further comprises a mounting in which the shaft of the flyer rotates, and a volute for recovering the gases, which radially surrounds the flyer and is rigidly connected to said mounting.

3. The drive chain according to either claim 1, wherein said assistance drive module comprises at least two flyers arranged in a line for driving the same power transmission shaft.

4. The drive chain according to claim 1, wherein said assistance drive module comprises a mechanical output arranged to directly drive a mechanical input of the main transmission gearbox.

5. The drive chain according to claim 1, wherein said assistance drive module comprises a mechanical output arranged to drive the same power transmission shaft connected to the main transmission gearbox as the main engine.

6. The drive chain according to claim 1, wherein the main engine is a turbine engine and said assistance drive module comprises a mechanical output coupled to the spindle of a turbine of the turbine engine.

7. The drive chain according to claim 1, wherein said assistance drive module further comprises a system for igniting the or said pyrotechnic gas generation device(s), it being possible to place said ignition system in an armed mode or a deactivated mode.

8. A helicopter comprising a drive chain according to claim 1.

9. The method for driving the rotary wing of a helicopter comprising a drive chain according to claim 7, comprising a step of arming said system for igniting the assistance drive module when a helicopter pilot orders a predetermined manoeuvre, for example autorotation.
